(19) United States
(12) Patent Application Publication
(10) Pub. No.: US 2013/0293903 A1
(43) Pub. Date: Nov. 7, 2013

(54) PRINTING APPARATUS, CONTROL METHOD THEREOF, AND STORAGE MEDIUM

(71) Applicant: CANON KABUSHIKI KAISHA, TOKYO (JP)

(72) Inventor: Tadanori Nakatsuka, Kawasaki-shi (JP)

(73) Assignee: CANON KABUSHIKI KAISHA, TOKYO (JP)

(21) Appl. No.: 13/863,195

(22) Filed: Apr. 15, 2013

(30) Foreign Application Priority Data
May 7, 2012 (JP) 2012-106315

(51) Int. Cl. G06K 15/02

(52) U.S. Cl. CPC G06K 15/1867
USPC 358/1.9

(57) ABSTRACT

There are provided a printing apparatus which adjusts printing according to a color attribute of an original determined by reading when printing is executed for an original to be read, a control method thereof, and a program. To accomplish this, this printing apparatus reads an original to determine a color attribute of the original, converts data of a print image so that a color attribute of the data of the print image corresponds to the determined color attribute of the original, and prints the print image on the original.

### BACKGROUND OF THE INVENTION

1. Field of the Invention

The present invention relates to a printing apparatus, a control method thereof, and a storage medium.

2. Description of the Related Art

Japanese Patent Laid-Open No. 2000-185881 has proposed a printing apparatus which commonly uses an original conveyance system and transfer sheet conveyance system by disposing an image reading unit in a transfer sheet conveyance path which extends from a feeding unit to a paper discharge unit.

However, the aforementioned related art suffers the following problem. For example, the printing apparatus of Japanese Patent Laid-Open No. 2000-185881 cannot execute printing for a read original. Even when printing can be executed for an original, whether to execute monochrome or color printing has to be judged according to the contents of the original. For example, although an original is a monochrome printed matter, when print data is color-printed, a color image printed later unwantedly stands out on an original beyond necessity.

### SUMMARY OF THE INVENTION

The present invention enables realization of a printing apparatus, which adjusts printing according to a color attribute of an original determined by reading upon execution of printing for an original to be read, a control method thereof, and a storage medium.

One aspect of the present invention provides a printing apparatus comprising: a reading unit configured to read an original; a color attribute determination unit configured to determine a color attribute of the original read by the reading unit; a conversion unit configured to convert data of a print image so that a color attribute of the data of the print image corresponds to the color attribute of the original determined by the color attribute determination unit; and a printing unit configured to execute printing on the original according to the data of the print image converted by the conversion unit.

Another aspect of the present invention provides a printing apparatus comprising: a reading unit configured to read an original; a conveyance unit configured to convey the original using a double-sided conveyance path required to execute double-sided printing; a color attribute determination unit configured to determine a color attribute of the original read by the reading unit; and a printing unit configured to print an image on the original conveyed by the conveyance unit according to the color attribute of the original determined by the color attribute determination unit.

Still another aspect of the present invention provides a control method of a printing apparatus, comprising: controlling a reading unit to read an original; controlling a color attribute determination unit to determine a color attribute of the original read by the reading unit; controlling a conversion unit to convert data of a print image so that a color attribute of the data of the print image corresponds to the color attribute of the original determined by the color attribute determination unit; and controlling a printing unit to execute printing on the original according to the data of the print image converted by the conversion unit.

Yet still another aspect of the present invention provides a control method of a printing apparatus, comprising: controlling a reading unit to read an original; controlling a color attribute determination unit to determine a color attribute of the original read by the reading unit; and controlling a printing unit to print an image on the original conveyed along a double-sided conveyance path for double-sided printing according to the color attribute of the original determined by the color attribute determination unit.

Still yet another aspect of the present invention provides a non-transitory computer-readable storage medium storing a computer program for controlling a computer to execute respective steps of a control method of a printing apparatus.

Further features of the present invention will be apparent from the following description of exemplary embodiments with reference to the attached drawings.

### BRIEF DESCRIPTION OF THE DRAWINGS

FIG. 1 is a schematic view of an image forming apparatus with a copy function according to the first embodiment;

FIG. 2 is an explanatory view of a double-sided printing process according to the first embodiment;

FIG. 3 is an explanatory view at the beginning of reading of an original obverse face according to the first embodiment;

FIG. 4 is an explanatory view at the end of reading of a first face as the original obverse face according to the first embodiment;

FIG. 5 is an explanatory view at the beginning of reading of a second face as an original reverse face according to the first embodiment;

FIG. 6 is an explanatory view at the end of reading of the original reverse face according to the first embodiment;

FIG. 7 is an explanatory view of completion of image formation on a printing material S according to the first embodiment;

FIG. 8 is an explanatory view at the beginning of image formation on an original according to the first embodiment;

FIGS. 9A and 9B are schematic views of color image formation according to the first embodiment;

FIG. 10 is a block diagram for explaining an operation of a control CPU according to the first embodiment;

FIG. 11 is a block diagram for explaining the arrangement of an image reading unit according to the first embodiment;

FIG. 12 is a flowchart for explaining the operation of the control CPU according to the first embodiment;

FIG. 13 is a flowchart for explaining the operation of a control CPU according to the second embodiment;

FIG. 14 is a flowchart for explaining the operation of a control CPU according to the third embodiment; and

FIG. 15 is a view for explaining the operation of the control CPU according to the third embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### Printing Apparatus

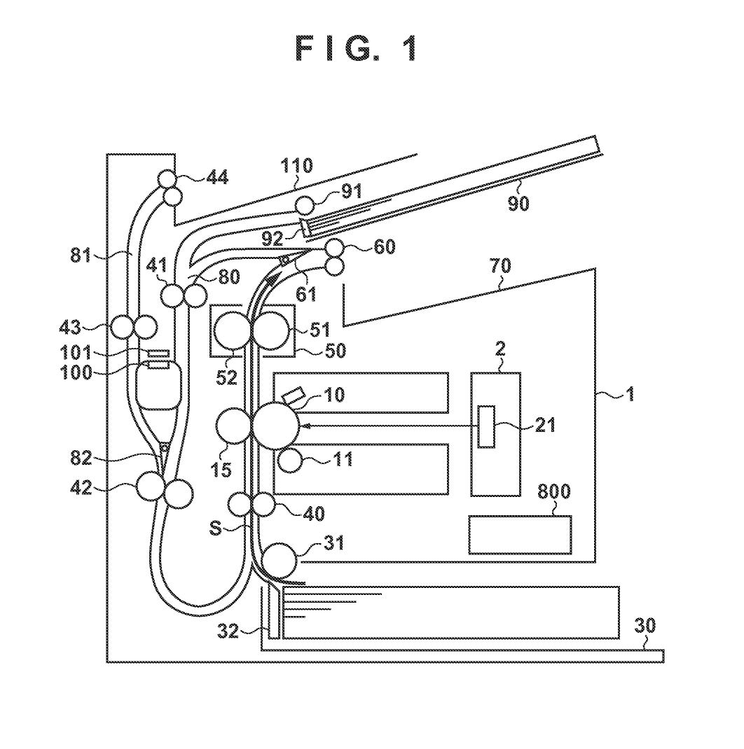

An image reading process and printing process in a printing apparatus will be described below with reference to FIGS. 1 to 11. Note that operations executed when two faces of an original G fed from a second feeding unit 90 are read, and images read from the original G are formed on two faces of a sheet S fed from a first feeding unit 30 will be described. An arrangement example of the printing apparatus will be described first with reference to FIG. 1. At the center of a printing apparatus 1, a rotatable photosensitive drum 10 which serves as an image carrier, and a developing roller 11 which is juxtaposed with the photosensitive drum 10 and is rotated while holding toner are disposed. Upon reception of a printing signal, a light emitting unit 21 included in an optical unit 2 irradiates the surface of the rotating photosensitive drum 10 with a laser beam. On the surface of the photosensitive drum 10 irradiated with the laser beam, a latent image is formed by charges. The developing roller 11 supplies held toner to the latent image on the surface of the photosensitive drum 10 while being rotated. Thus, a toner image is formed on the surface of the photosensitive drum 10.

On the other hand, sheets S stored in a first feeding unit 30 are conveyed one by one to conveyance rollers 40 by a CST pickup roller 31 and separation unit 32. The conveyance rollers 40 convey the sheet S to a transfer unit 15 to adjust timings of the toner image on the surface of the photosensitive drum 10 and a leading edge position of the sheet S. Note that the sheet indicates a medium on which the printing apparatus 1 can print an image, and can include, for example, media of various materials such as paper and an OHP sheet.

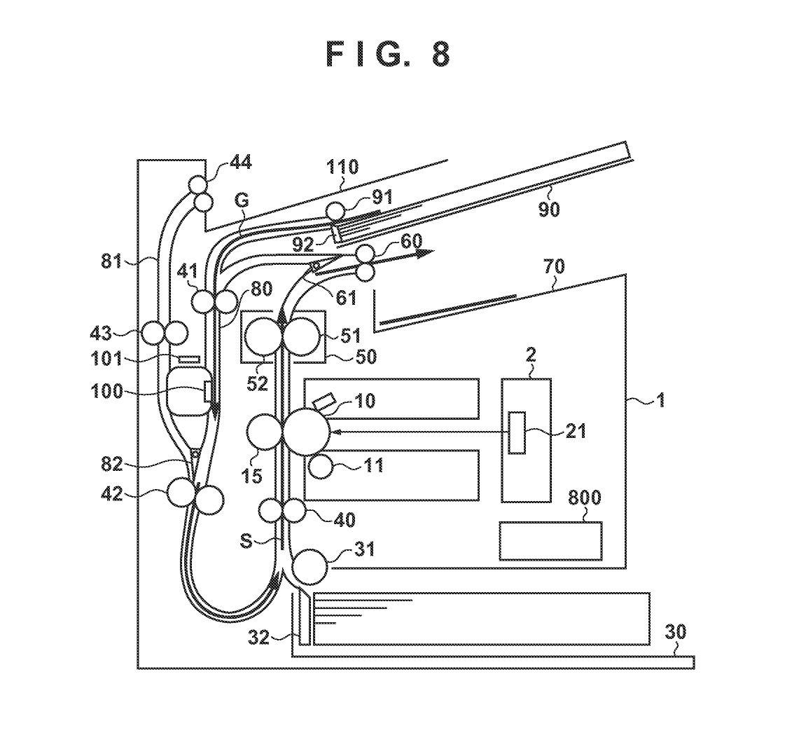

The toner image conveyed to the transfer unit 15 upon rotation of the photosensitive drum 10 is transferred to the sheet S by an application bias and pressure given to the transfer unit 15. Furthermore, the transfer unit 15 conveys the sheet S to a fixing unit 50. In the fixing unit 50, heat from a rotatable heating roller 51 and a pressure from a rotatable pressure roller 52 which opposes the heating roller 51 fix the toner image on the sheet S. The sheet S on which the toner image is fixed is conveyed to discharge rollers 60. In case of one-sided printing, the discharge rollers 60 directly convey the sheet S outside the apparatus, and the sheet S is stacked on a first discharge unit 70. Respective components of the printing apparatus 1 are controlled by electric components 800, which will be described later with reference to FIG. 8. Note that a conveyance path along which a sheet fed from the first feeding unit 30 is printed, and is discharged onto the first discharge unit 70 will be referred to as a first conveyance path hereinafter.

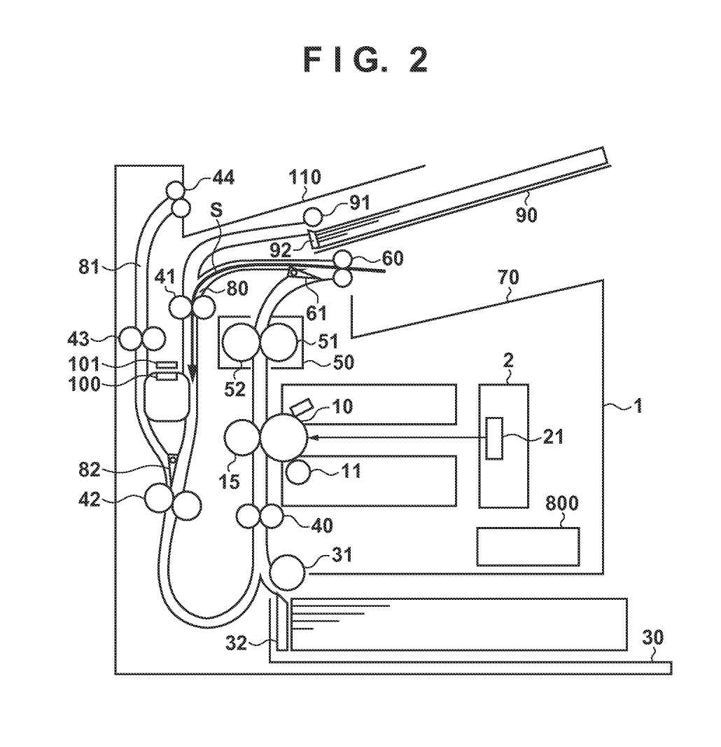

A double-sided printing process will be described below with reference to FIG. 2. A double-sided flapper 61 switches a conveyance path after the trailing edge of the sheet S passed. After that, the discharge rollers 60 are rotated in a reverse direction to convey the sheet S onto a double-sided conveyance path (second conveyance path) 80. The sheet S, which has been switched back, is conveyed to an image reading unit 100 via conveyance rollers 41. As shown in FIG. 2, the image reading unit 100 is arranged in the vicinity of the double-sided conveyance path 80. After that, the sheet S is conveyed by conveyance rollers 42 and 40, and is conveyed to the transfer unit 15 again. Then, a toner image is transferred onto a reverse face (a face different from the transfer face described using FIG. 1) of the sheet S, and the sheet S is then stacked on the first discharge unit 70 via the fixing unit.

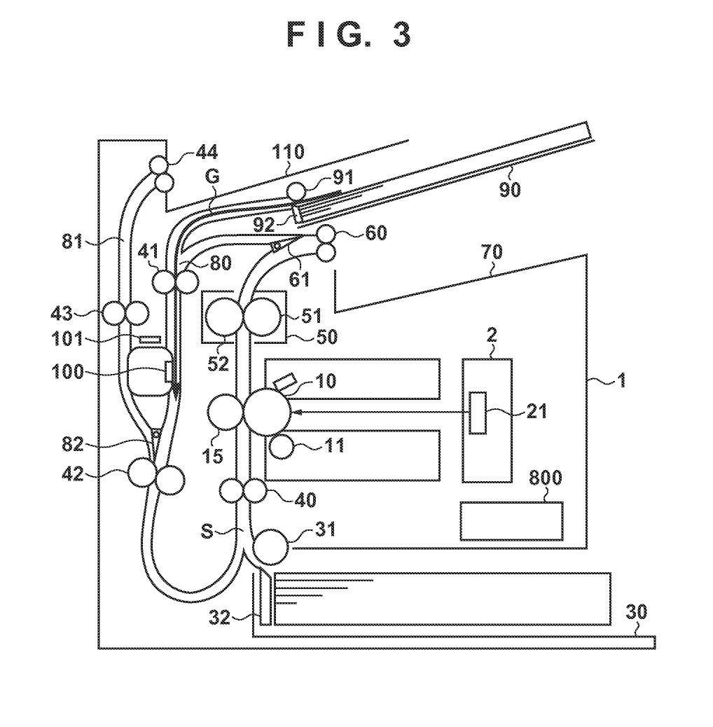

A process for reading original information and executing double-sided printing on a sheet will be described below with reference to FIG. 3. Originals G placed on a second feeding unit 90 are conveyed one by one to the conveyance rollers 41 by a CIS pickup roller 91 and separation unit 92. On the other hand, the image reading unit 100 emits light toward a white reference member 101 and corrects a white reference value until the beginning of reading of a first face as an original obverse face of an original G fed from the second feeding unit 90. After that, the image reading unit 100 is turned to a position (that shown in FIG. 3) facing the double-sided conveyance path 80. That is, the image reading unit 100 is turned to the position where it can read an image of the original G conveyed along the double-sided conveyance path 80. The conveyance rollers 41 convey the original G to the image reading unit 100. The image reading unit 100 already stands by at the position facing the double-sided conveyance path 80, and information read by the image reading unit 100 is stored in an image memory 804 (to be described later with reference to FIG. 8) as information of the original first face. Note that the white reference member 101 is arranged facing down to take a measure against attachment of dust.

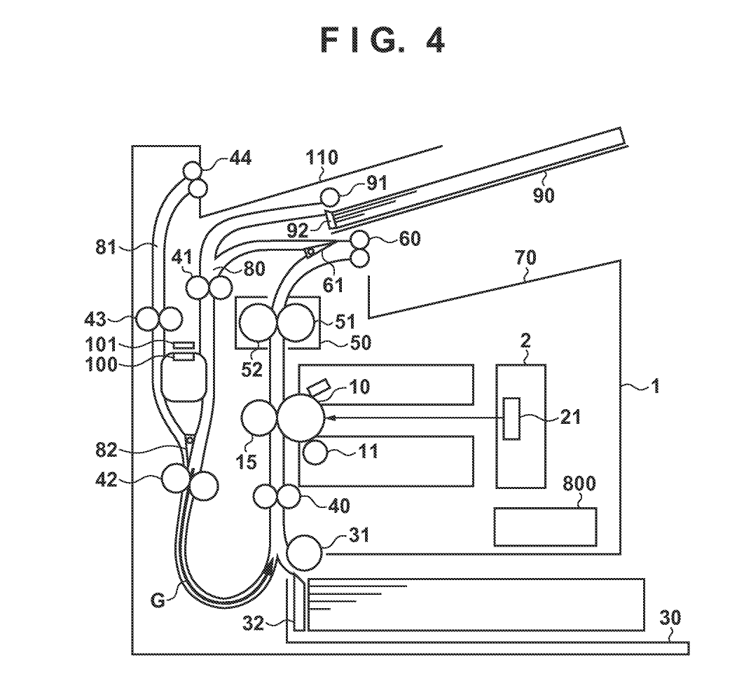

An operation at the end of reading of the first face as the original obverse face will be described below with reference to FIG. 4. The original G which has passed through the image reading unit 100 is conveyed to the conveyance rollers 42. The conveyance rollers 42 are stopped when the trailing edge of the original G has passed through a switchback flapper 82. In this case, the original G is stopped in a state in which it is clamped by the conveyance rollers 42. After an elapse of a predetermined time period, the conveyance rollers 42 are rotated in a reverse direction, and convey the original G onto an original dedicated conveyance path (third conveyance path) 81. The original dedicated conveyance path 81 branches from the double-sided conveyance path 80, and is connected to a second discharge unit 110. At this time, the original G may be conveyed to the conveyance rollers 40 without being stopped by the conveyance rollers 42 to read the first face, and may then be passed to the image formation process described using FIG. 1.

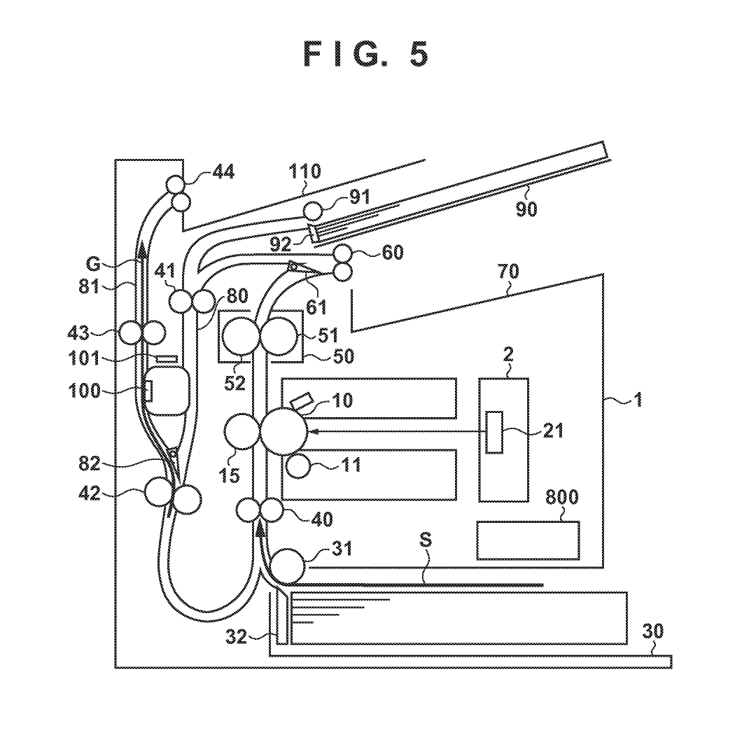

An operation at the beginning of reading of a second face as the reverse face of the first face will be described below with reference to FIG. 5. Simultaneously when the switchback flapper 82 switches the conveyance path from the double-sided conveyance path 80 to the original dedicated conveyance path 81, the image reading unit 100 is turned to the a position facing the original dedicated conveyance path 81. That is, the image reading unit 100 is turned to a position where it can read an image of a sheet conveyed along the original dedicated conveyance path 81. When the conveyance rollers 42 are rotated in a reverse direction, the original G is conveyed to the image reading unit 100 along the original dedicated conveyance path 81. When the original G is conveyed to and passes through the image reading unit 100, information of the second face as the original reverse face is read, and is stored in the image memory 804 as that of the original second face. In this way, the image reading unit 100 is arranged to be sandwiched between the double-sided conveyance path 80 and original dedicated conveyance path, and to be movable so as to read images of a sheet conveyed along both the conveyance paths.

When reading of the second face of the original G is started, a sheet S fed from the first feeding unit 30 is conveyed one by one to the conveyance rollers 40. At nearly the same time, based on the read image of the second face as the original reverse face stored in the image memory 804, a latent image is formed on the photosensitive drum 10 by a laser beam emitted from the light emitting unit 21 based on the above image information. Next, a toner image formed based on the latent image is transferred onto the sheet S by the transfer unit 15, and is conveyed to the fixing unit 50 and the like, thus completing image formation of the original second face. Note that in FIG. 5, feeding of the sheet S is started simultaneously with the beginning of reading of information of the second face as the original reverse face. Alternatively, after the information of the second face is read, the sheet S may be conveyed.

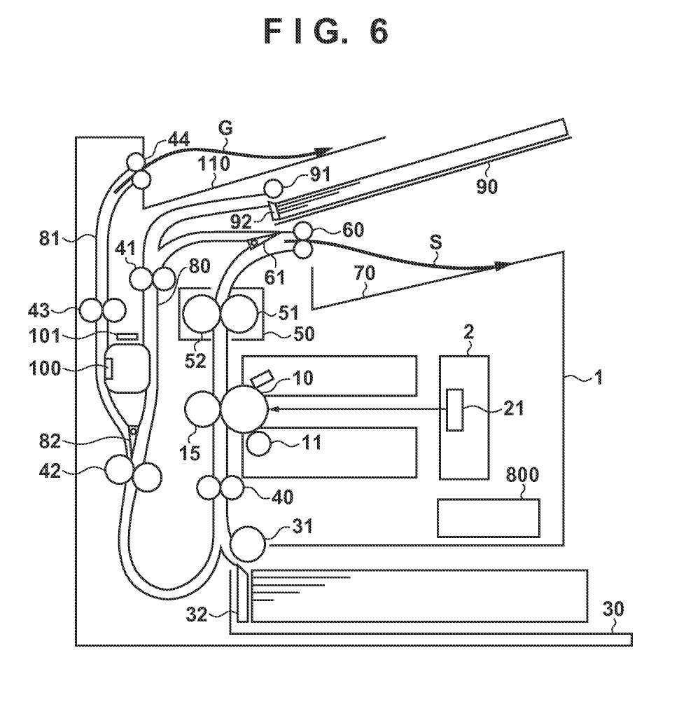

An operation at the end of reading of the original reverse face will be described below with reference to FIG. 6. The original G whose image reading is complete is conveyed by conveyance rollers 43 and 44, and is stacked on the second discharge unit 110. The switchback flapper 82 switches the conveyance path from the original dedicated conveyance path 81 to the double-sided conveyance path 80 so as to convey the sheet S whose double-sided printing has been started in a direction of the conveyance rollers 40, when the trailing edge of the original G has passed. The sheet S on which image formation of the second face read from the original G is complete is conveyed toward the double-sided conveyance path 80 switched by the double-sided flapper 61 by rotating the discharge rollers 60 in a reverse direction, so as to form an image on its reverse face. At this time, in place of conveying the sheet S onto the double-sided conveyance path 80, the original G may be stopped at the conveyance rollers 44 and may be reversed to be returned onto the original dedicated conveyance path 81. Then, the original G may be conveyed to the conveyance rollers 40 to pass through the conveyance rollers 43 and 42, thus forming images on the original G, the two faces of which have been read.

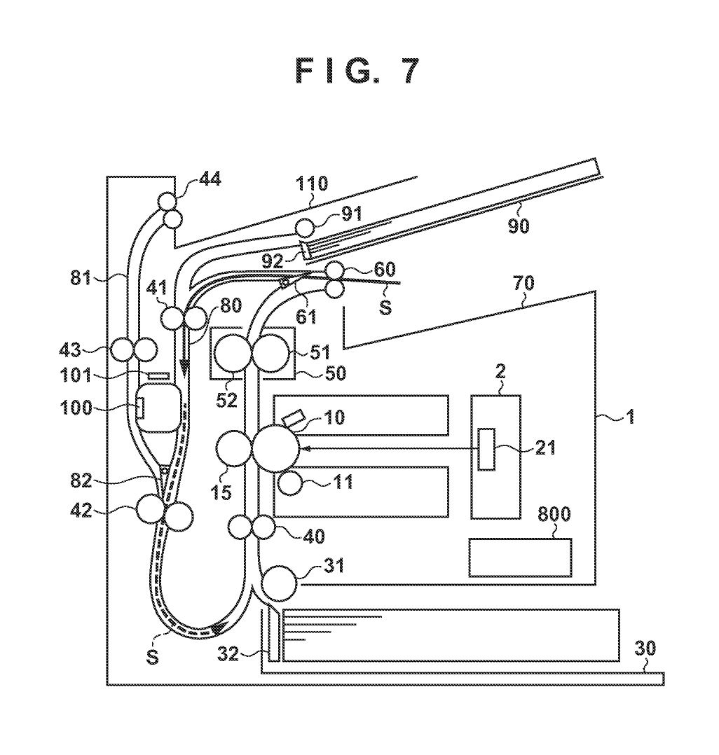

An operation upon completion of image formation on the sheet S will be described below with reference to FIG. 7. The sheet S conveyed onto the double-sided conveyance path 80 passes through the reversed image reading unit 100, is conveyed to the conveyance rollers 40 via the conveyance rollers 42, and is further conveyed to the transfer unit 15, like the sheet S indicated by a broken line. Since image formation of the second face of the original is already complete on the sheet S, the image of the original first face is formed on the sheet S based on the image information of the original first face previously stored in the image memory 804. More specifically, a toner image is transferred and fixed on the sheet S by an image forming unit including the optical unit 2, photosensitive drum 10, developing roller 11, transfer unit 15, and fixing unit 50, and that sheet S is discharged and stacked on the first discharge unit 70.

As described above, the printing apparatus 1 according to this embodiment can execute printing and image reading with respect to the sheet S fed from the first feeding unit 30. Also, the printing apparatus 1 can execute image reading and printing with respect to the original G fed from the second feeding unit 90. The image reading unit 100 may be controlled to read the first and second faces of the sheet or original by reading the sheet S or original G conveyed along the double-sided conveyance path 80 and the sheet S or original G conveyed along the original dedicated conveyance path.

Processing for reading the original G and printing an image on the read original G (on-print processing) will be described below with reference to FIG. 8. When a control CPU 801 of the printing apparatus 1 receives an on-print command and contents to be printed (image to be printed), which are instructed from a host computer (not shown), it stores the contents to be printed in the image memory 804, and starts the on-print processing. The on-print command is a command which requests to further execute printing on an original which has undergone printing in advance.

The originals G placed on the second feeding unit 90 are conveyed one by one to the conveyance rollers 41 by the CIS pickup roller 91 and separation unit 92. On the other hand, the image reading unit 100 emits light toward the white reference member 101 and corrects a white reference value until the beginning of reading of the first face as the original obverse face of the original G fed from the second feeding unit 90. After that, the image reading unit 100 is turned to the position facing the double-sided conveyance path 80. The conveyance rollers 41 convey the original G to the image reading unit 100. The image reading unit 100 already stands by at the position facing the double-sided conveyance path 80, and information read by the image reading unit 100 is stored in the image memory 804 in FIG. 8 as information of the original first face.

The original G which has passed through the image reading unit 100 is conveyed to the conveyance rollers 42, and then to the conveyance rollers 40. At nearly the same time, the light emitting unit 21 irradiates the surface of the photosensitive drum 10 with a laser beam based on the image information stored in the image memory, thereby forming a latent image based on the image information on the surface of the photosensitive drum 10. After that, the latent image is developed by toner supplied from the developing roller 11. The conveyance rollers 40 convey the original G to the transfer unit 15 so as to adjust the timings of the toner image on the surface of the photosensitive drum 10 and the leading edge position of the original G. The toner image conveyed to the transfer unit 15 upon rotation of the photosensitive drum 10 is transferred onto the original G by an application bias and pressure given to the transfer unit 15. Furthermore, the transfer unit 15 conveys the original G to the fixing unit 50. In the fixing unit 50, heat from the rotatable heating roller 51 and a pressure from the rotatable pressure roller 52 which opposes the heating roller 51 fix the toner image on the original G. The original G on which the toner image is fixed is conveyed to the discharge rollers 60.

In case of one-sided printing, the discharge rollers 60 directly convey the original G outside the apparatus, and the original G is stacked on the first discharge unit 70. In this manner, information on the original is read, and an image is formed on the read original.

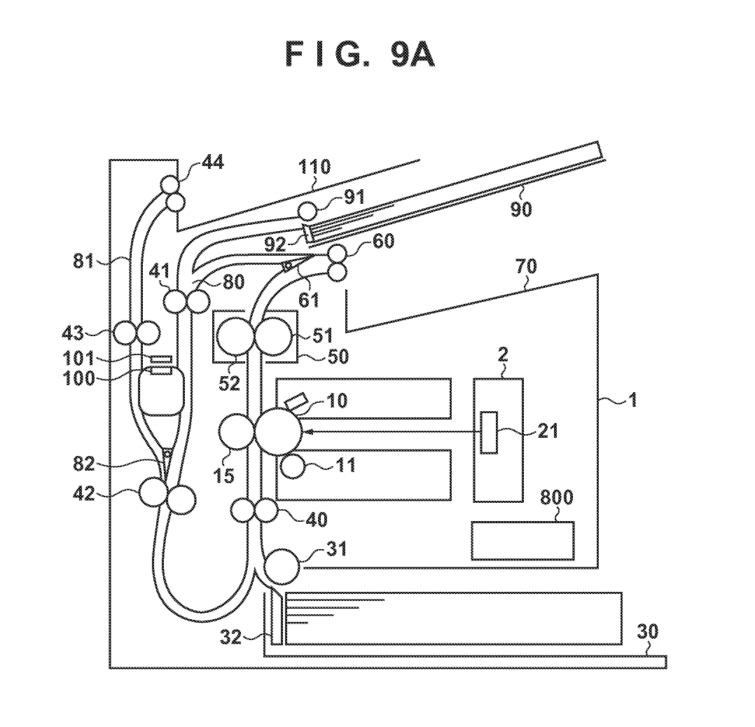

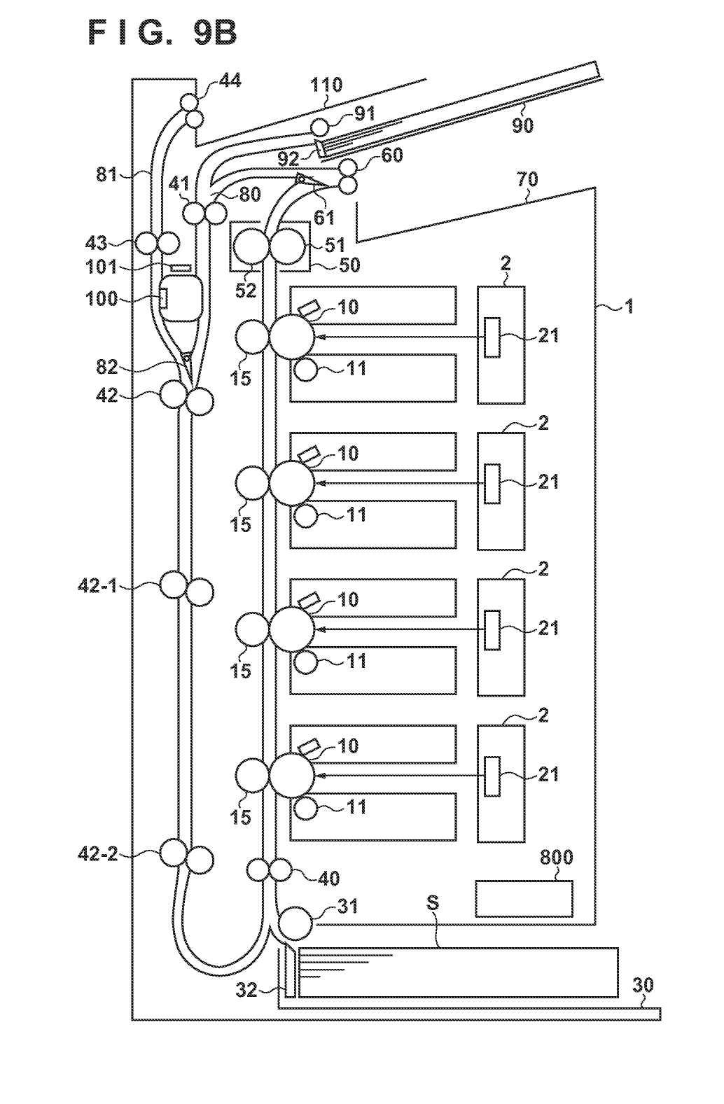

The arrangements of printing apparatuses which respectively form a monochrome image and color image according to this embodiment will be described below with reference to FIGS. 9A and 9B. FIG. 9A shows the same printing apparatus as the printing apparatus 1 which has been described using FIGS. 1 to 8. In this embodiment, the following description will be given using the arrangement of the printing apparatus 1 shown in FIG. 1 for the sake of simplicity. However, the printing apparatus of the present invention has the arrangement of the printing apparatus 1 shown in FIG. 9A. FIG. 9B shows the printing apparatus 1 which can execute color printing according to the present invention. The printing apparatus 1 includes optical units 2, photosensitive drums 10, developing rollers 11, and transfer units 15 which respectively correspond to C (Cyan), M (Magenta), Y (Yellow), and Bk (black). Note that in the following description, movements of the original G and sheet S will be described in detail by simplifying the arrangement shown in FIG. 9B like FIG. 9A.

### Arrangement of Control Unit

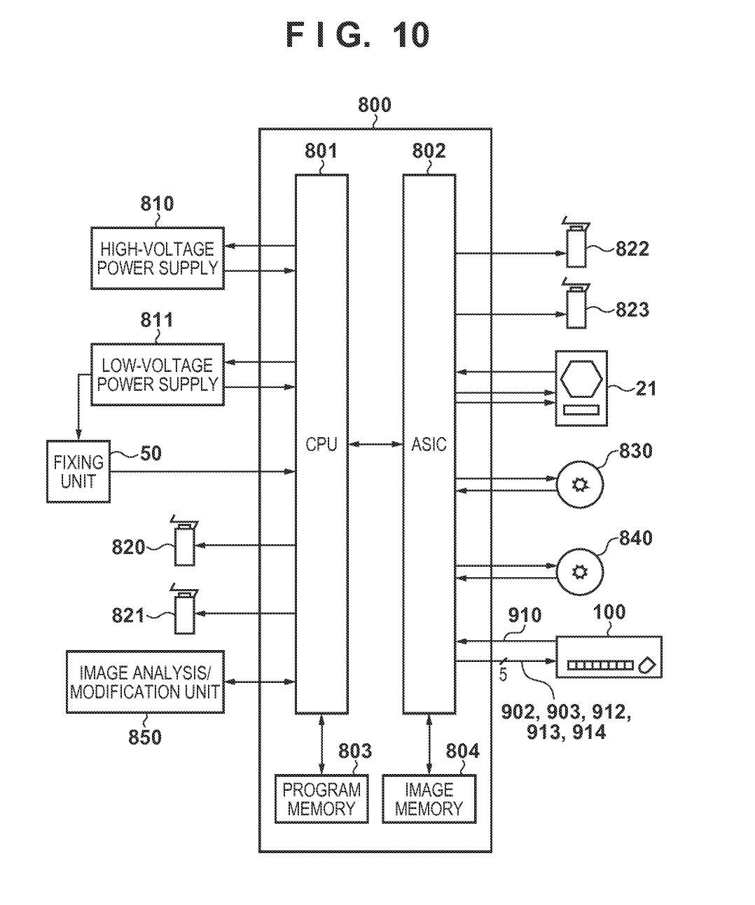

Operations of a control CPU 801 and ASIC 802 in image forming operations of this embodiment will be described below with reference to FIG. 10. FIG. 10 shows the arrangement of respective units controlled by the control CPU 801. The control CPU 801 is connected to the light emitting unit 21 including a polygon mirror, motor, laser emitting element, and the like via the ASIC 802, as shown in FIG. 10. The control CPU 801 outputs a control signal to the ASIC 802 to draw a desired latent image by scanning the surface of the photosensitive drum 10 with a laser beam, thereby controlling the optical unit 2. Likewise, the control CPU 801 controls a driving system including a main motor 830 required to drive the CST pickup roller 31 and conveyance rollers 40, photosensitive drum 10, transfer unit 15, heating roller 51, and pressure roller 52, so as to convey the sheet S, a CST feeding solenoid 822 which is turned on at the beginning of driving of the feeding roller used to feed the sheet S and is required to drive the CST pickup roller 31, a double-sided driving motor 840 required to drive the CIS pickup roller 91 and conveyance rollers 41 to 44, and the like.

Furthermore, the control CPU 801 controls a high-voltage power supply 810, the fixing unit 50, and a low-voltage power supply 811, which are required to control primary charge, developing, primary transfer, and secondary transfer biases required for an electrophotographic process. Furthermore, the control CPU 801 monitors a temperature using a thermistor (not shown) included in the fixing unit 50, and controls to maintain a constant fixing temperature. Also, the control CPU 801 is connected to a program memory 803 via a bus and the like (not shown). The program memory 803 stores programs and data required to execute the aforementioned control and all or some of processes to be implemented by the control CPU 801 in respective embodiments described in this specification. That is, the control CPU 801 executes operations of the respective embodiments of the present invention using the programs and data stored in the program memory 803.

The ASIC 802 executes motor speed control in the light emitting unit 21 and speed control of the main motor 830 and double-sided driving motor 840 based on instructions from the control CPU 801. In the motor speed control, tach signals (pulse signals output from the motor every time a motor (not shown) is rotated) from the motor are detected, and an acceleration or deceleration signal is output to the motor so that an interval between the detected tach signals matches a predetermined time interval. In this manner, a control circuit is preferably configured by a hardware circuit of the ASIC 802 to reduce the control load on the control CPU 801.

Upon reception of a print command instructed from a client PC, the control CPU 801 drives the main motor 830, double-sided driving motor 840, and CST feeding solenoid 822 to convey the sheet S. After a toner image formed on the surface of the photosensitive drum 10 is transferred onto the sheet S by the transfer unit 15, that toner image is fixed on the sheet S by the fixing unit 50, and the sheet S is then discharged by the discharge rollers 60 onto the first discharge unit 70 as a sheet stacking unit. In order to neatly align image formed sheets, the first discharge unit 70 has a gentle rising slope from the vicinity of a discharge port in a sheet discharge direction. The control CPU 801 supplies predetermined electric power to the fixing unit 50 via the low-voltage power supply 811 to generate a desired heat amount, which is to be given to the sheet S, thereby melting and fixing a toner image on the sheet S.

An original reading operation will be described below. Upon reception of a scan command instructed from a client PC, the control CPU 801 drives a double-sided flapper solenoid 820 and the double-sided driving motor 840. Furthermore, the control CPU 801 operates the CIS feeding solenoid to transfer a torque of the double-sided driving motor 840 to the CIS pickup roller 91, thereby conveying the original G. Also, the image reading unit 100 is connected to the ASIC 802 via various control signals CISLED, CISSTART, SYSCLK, S1_in, S1_select, and S1_out (to be described later). The control CPU 801 saves an image read from the image reading unit 100 based on various control signals via the ASIC 802 in the image memory 804 connected to the ASIC 802. After that, the control CPU 801 operates a switchback solenoid 821 to flip the switchback flapper 82 toward the original dedicated conveyance path side, and reverses the double-sided driving motor 840, thereby conveying the original G to the second discharge unit 110. An image analysis/modification unit 850 analyzes an image read from the original G to determine whether the original G is a monochrome (single-color) or color original, and corrects the image data.

### Image Reading Unit

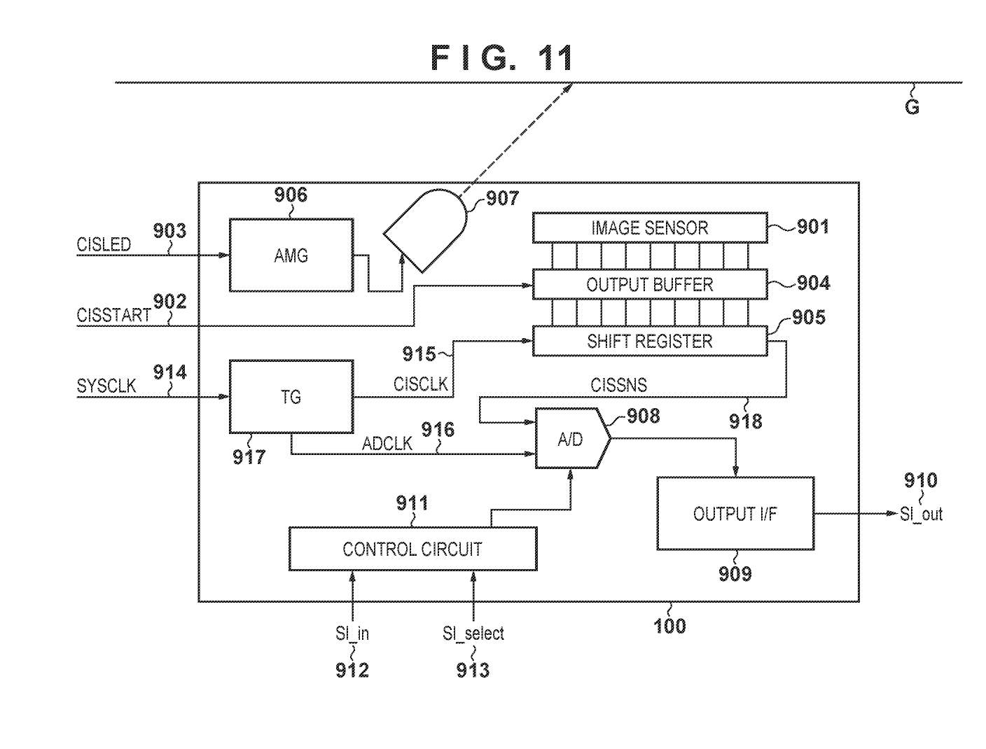

Details of the image reading unit 100 will be described below with reference to FIG. 11. FIG. 11 shows a circuit block of a CIS sensor (Contact Image Sensor). Reference numeral 901 denotes a contact image sensor unit in which, for example, photodiodes as many as 10368 pixels are arranged in an array at a specific main scanning density (for example, 1200 dpi). Reference numerals 902 and 915 respectively denote a start pulse CISSTART signal and transfer clock CISCLK to be supplied to the CIS sensor. Reference numeral 914 denotes a system block SYSCLK required to decide the operation speed of the CIS sensor unit. Reference numeral 908 denotes an A/D converter. Reference numeral 916 denotes a CIS sampling clock ADCLK required to decide a sampling rate of the A/D converter 908. Reference numeral 917 denotes a timing generator. Reference numeral 904 denotes an output buffer. Reference numeral 905 denotes a shift register. Reference numeral 903 denotes a light emitting element control signal CISLED. Reference numeral 906 denotes a current amplifier. Reference numeral 907 denotes a light emitting element which irradiates the original G with uniform light.

The operation of the image reading unit will be described below. When the CISSTART signal 902 is activated, the CIS sensor unit 901 begins to accumulate charges based on received light, and sequentially sets data in the output buffer 904. Next, when the transfer clock CISCLK 915 (for example, about 500 kHz to 1 MHz) is input, the shift register 905 transfers data set in the output buffer 904 to the A/D converter 908 as a CISSNS signal 918. Since this CISSNS signal 918 includes a predetermined data guarantee field, it has to be sampled after an elapse of a predetermined time period since a rising timing of the transfer clock CISCLK 915. Also, the CISSNS signal 918 is output in synchronism with both rising and falling edges of the transfer clock CISCLK 915. For this reason, the CIS sampling clock ADCLK 916 is generated to have a frequency twice that of the transfer clock CISCLK 915, and the CISSNS signal 918 is sampled in synchronism with the rising edge of the CIS sampling block ADCLK 916.

The timing generator 917 generates the CIS sampling clock ADCLK 916 and transfer clock CISCLK 915 by frequency-dividing the system clock SYSCLK 914. The phase of the CIS sampling clock ADCLK 916 is delayed by the aforementioned data guarantee field from the transfer clock CISCLK 915.

The CISSNS signal 918 converted into digital data by the A/D converter 908 is controlled at a predetermined timing by an input interface circuit 909, and is output as serial data to an S1_out signal 910. In this case, an analog output reference voltage is output as the CISSNS signal 918 for the predetermined number of pixels since the start pulse CISSTART 902, and corresponding data cannot be used as effective pixels. On the other hand, a control circuit 911 can variable-control an A/D conversion gain of the A/D converter 908 by an S1_in signal 912 and S1_select signal 913. For example, when the contrast of a captured image cannot be obtained, the control CPU 801 increases the A/D conversion gain of the A/D converter 908 to increase the contrast, thus always allowing an image capturing operation with the best contrast.

In this embodiment, the description has been given using a system in which all pixels are output as one output CISSNS signal 918. However, pixels may be divided into a plurality of areas, and A/D conversion may be simultaneously executed for the plurality of areas for the sake of quick reading. Also, the embodiment described so far has been described using the CIS sensor in the image reading unit 100. However, the present invention is not limited to this, and a CMOS sensor, CCD sensor, and the like are applicable, needless to say.

### On-print Processing

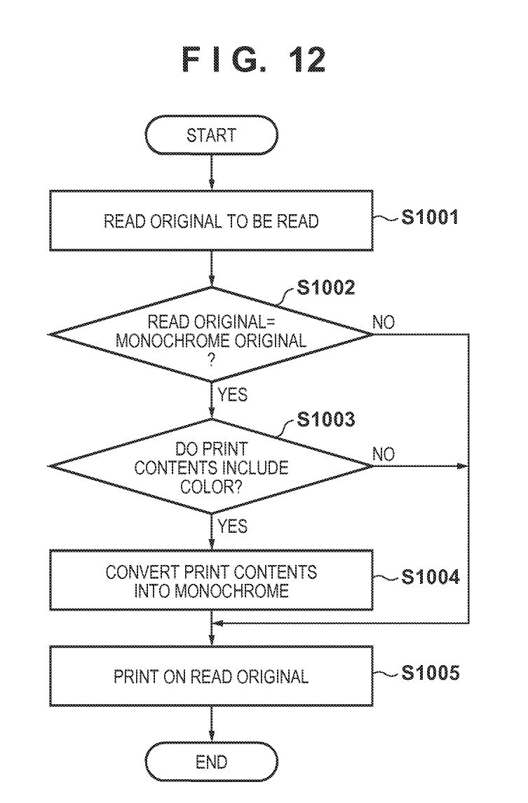

On-print processing for reading a monochrome or color preprint sheet as an original, modifying print data contents, and executing printing on that original will be described below with reference to FIG. 12. The on-print processing indicates processing for executing printing on a read original. The print data contents indicate PDL data or a print image obtained by rasterizing PDL data, and will be referred to as print contents hereinafter. The processing to be described below can be implemented when the control CPU 801 executes a control program stored in the program memory 803.

When the control CPU 801 receives automatic color correction on-print commands and print contents instructed from a host computer as an external apparatus connected via a network, it stores the print contents in the image memory 804, and starts the on-print processing. These print commands may be issued by a user operation via an operation unit of the printing apparatus 1. If commands received from the host computer instruct on-print processing without automatic color correction, a read image is printed intact on a read original. The automatic color correction on-print processing will be described below.

In step S1001, the control CPU 801 controls the image reading unit 100 to read an original to be read (preprint sheet). The detailed operation is as has been described above using FIG. 8. An original G placed on the second feeding unit 90 is conveyed and read by the image reading unit 100, and a read original image is stored in in the image memory 804.

In step S1002, the control CPU 801 controls the image analysis/modification unit 850 to analyze the read original image so as to determine whether or not the original G is a monochrome original (color attribute). More specifically, the image analysis/modification unit 850 confirms if the read original image stored in the image memory 804 in step S1001 has color pixels other than black, white and gray pixels. If the read original image has only black, white, and gray pixels, the image analysis/modification unit 850 determines that the original G is a monochrome original, and the process advances to step S1003; otherwise, it determines that the original G is a color original, and the process jumps to step S1005. For example, if a set preprint sheet is a monochrome preprint sheet used for the confirmation purpose in the office, the process advances to step S1003 to confirm whether or not print contents to be printed include color contents. If a set preprint sheet is a color preprint sheet to be distributed to customers, the process jumps to step S1005 to print a read image on the preprint sheet.

The control CPU 801 determines in step S1003 whether or not a print content image stored in the image memory 804 includes color contents, that is, it has color pixels other than black, white, and gray pixels. Note that the print content image stored in the image memory 804 indicates an image to be printed on the original G. If the print content image includes color content, the process advances to step S1004; otherwise, the process jumps to step S1005. For example, since print data to be distributed to customers is color data, the process advances to step S1004.

In step S1004, the control CPU 801 controls the image analysis/modification unit 850 to color-convert the print contents stored in the image memory 804 into monochrome data. Subsequently, in step S1005, the control CPU 801 prints the print content image on the conveyed read original G. More specifically, the original G read by the image reading unit 100 in step S1001 is conveyed directly to the conveyance rollers 40 by the conveyance rollers 42 along the conveyance path 80 in FIG. 8. The conveyance rollers 40 convey the original G to the transfer unit 15 to adjust timings of a toner image on the surface of the photosensitive drum 10 and the leading edge position of the original G. The toner image conveyed to the transfer unit 15 upon rotation of the photosensitive drum 10 is transferred onto the original G by an application bias and pressure given to the transfer unit 15. Furthermore, the transfer unit 15 conveys the original G to the fixing unit 50. In the fixing unit 50, heat from the rotatable heating roller 51 and a pressure from the rotatable pressure roller 52 which opposes the heating roller 51 fix the toner image on the original G. The original G on which the toner image is fixed is conveyed to the discharge rollers 60. In case of one-sided printing, the discharge rollers 60 directly convey the original G outside the apparatus, and the original G is stacked on the first discharge unit 70.

As described above, the printing apparatus 1 according to this embodiment can cope with a use case in which although print contents to be printed are created to include color contents, they are normally printed as a monochrome image or are printed as a color image in case of distribution to customers, so as to attain cost reduction. In this case, it is assumed that two types of preprint sheets used to offer an estimate are prepared, one type is a monochrome preprint sheet used for confirmation in the office, and the other type is a color preprint sheet to be presented to a customer. Conventionally, the user has to set the monochrome preprint sheet and make monochrome print settings and print settings of the required number of copies. Separately, for color printing, the user has to set the color preprint sheet and make color print settings and print settings of the required number of copies. Then, the user has to execute printing, resulting in much time-consuming operations.

However, the printing apparatus 1 according to this embodiment includes the conveyance path along which an image can be printed on the read document, and monochrome or color printing is switched according to a color attribute of the read original. Thus, the user need only set the required number of copies of monochrome and color preprint sheets together on the original reading feeding unit, thus allowing printing to have the same color attributes of the read originals (preprint sheets). As a result, the printing apparatus which does not require user's time-consuming operations and is free from any work efficiency drop can be realized.

### Second Embodiment

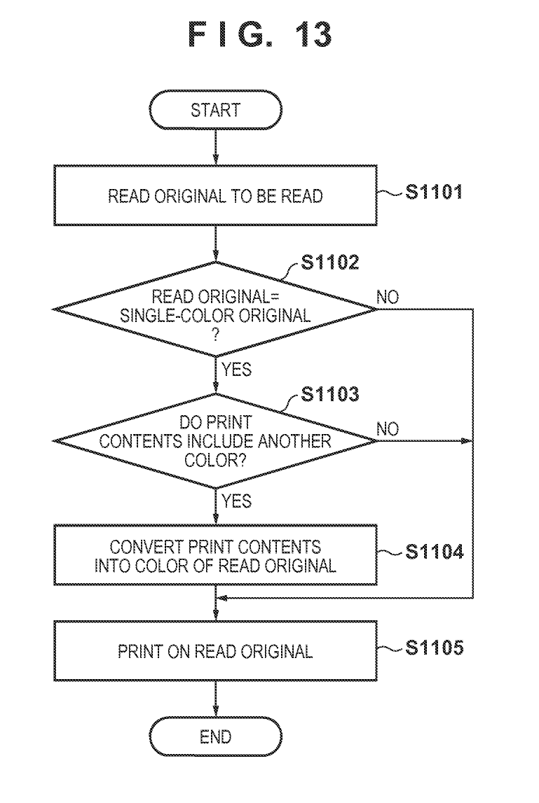

On-print processing for reading an original, modifying print contents, and printing the modified print contents on that original according to the second embodiment will be described below with reference to FIG. 13. In the first embodiment, whether or not an original is a monochrome original is determined as a color attribute of the original. However, this embodiment will exemplify a case in which whether or not an original is a single-color original is determined as a color attribute of the original. Processing to be described below is implemented when a control CPU 801 executes a control program stored in a program memory 803. When the control CPU 801 receives an automatic color correction on-print command and print contents instructed from a host computer, it stores the print contents in an image memory 804, and starts the on-print processing.

In step S1101, the control CPU 801 controls an image reading unit 100 to read an original to be read (preprint sheet). As described above using FIG. 3, an original G placed on a second feeding unit 90 is conveyed and read by the image reading unit 100, and a read original image is stored in in the image memory 804.

In step S1102, the control CPU 801 controls an image analysis/modification unit 850 to determine whether or not the read original is a single-color original. More specifically, the image analysis/modification unit 850 confirms if the read original image stored in the image memory 804 in step S1101 includes a single color. For example, when respective pixels of the original image have a constant R:G:B ratio of an RGB color except for white ((R, G, B)=(0, 0, 0)), since these pixels correspond to a single color, the image analysis/modification unit 850 determines that the read original is a single-color original. If the single-color original is determined, the process advances to step S1103; otherwise, the process jumps to step S1105.

The control CPU 801 determines in step S1103 whether or not the print content image stored in the image memory 804 includes colors other than the color determined in step S1102. If respective pixels of the print content image include color pixels, R:G:B ratios of which are different from the color ratio of the read original determined in step S1102, the process advances to step S1104. If the R:G:B ratio of the print content image is the same as that of the read original, the process jumps to step S1105.

In step S1104, the control CPU 801 color-converts the print content image stored in the image memory 804 to have the same color ratio as that of the read original. For example, when the color space of the read original is an RGB color space, and that of the print content image to be printed is a CMYK color space, the RGB color space is converted into the CMYK color space first. A case will be examined below wherein a color ratio of the read original is C:M:Y=1:2:3, and a color value of a certain pixel in the print content image is (C, M, Y)=(10, 30, 5). The color value is converted to have the same color ratio with reference to the highest value of the color value. However, when the color ratio includes 0, a color other than 0 is used. In the above example, since M=30 is highest, C=10 and Y=5 are converted into C=15 and Y=45 with reference to M. Likewise, pixels other than white of all the pixels of the print content image are color-converted.

When a printing apparatus uses a plurality of inks to print an image, a color value may be adjusted to that of a spot ink. That is, when it is determined that the color ratio of the read original is the same as that of the color value of the spot ink, color attribute conversion may be executed to fully print the print contents using the spot ink. As the color value of the spot ink, a value, which is set in advance in a device, is acquired.

In step S1105, the control CPU 801 prints the print content image on the conveyed read original G. More specifically, the original G read by the image reading unit 100 in step S1101 during conveyance along a conveyance path 80 is conveyed directly to conveyance rollers 40 by conveyance rollers 42 along the conveyance path 80. The conveyance rollers 40 convey the original G to a transfer unit 15 to adjust timings of a toner image on the surface of a photosensitive drum 10 and the leading edge position of the original G. The toner image conveyed to the transfer unit 15 upon rotation of the photosensitive drum 10 is transferred onto the original G by an application bias and pressure given to the transfer unit 15. Furthermore, the transfer unit 15 conveys the original G to a fixing unit 50. In the fixing unit 50, heat from the rotatable heating roller 51 and a pressure from the rotatable pressure roller 52 which opposes the heating roller 51 fix the toner image on the original G. The original G on which the toner image is fixed is conveyed to discharge rollers 60. In case of one-sided printing, the discharge rollers 60 directly convey the original G outside the apparatus, and the original G is stacked on a first discharge unit 70.

As described above, according to this embodiment, since the printing apparatus includes the conveyance path along which an image can be printed on the read document as in the first embodiment, adequate printing can be executed for each sheet with respect to sheets (originals) including both single-color preprint sheets and other preprint sheets. More specifically, a printing apparatus which can print an image to have the same color attribute as that of the read original (preprint sheet) and is free from any work efficiency drop without requiring any user's time-consuming operation even when sheets of such two types are mixed can be provided. Especially, if a single color is the same as the color of the spot ink, a printing apparatus which prints an image using the spot ink can be provided.

### Third Embodiment

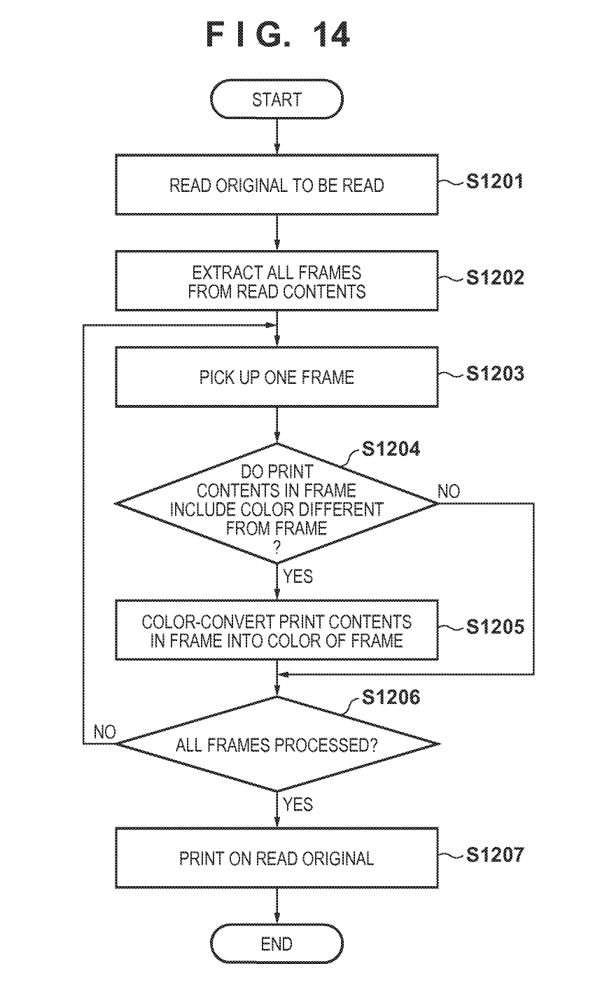

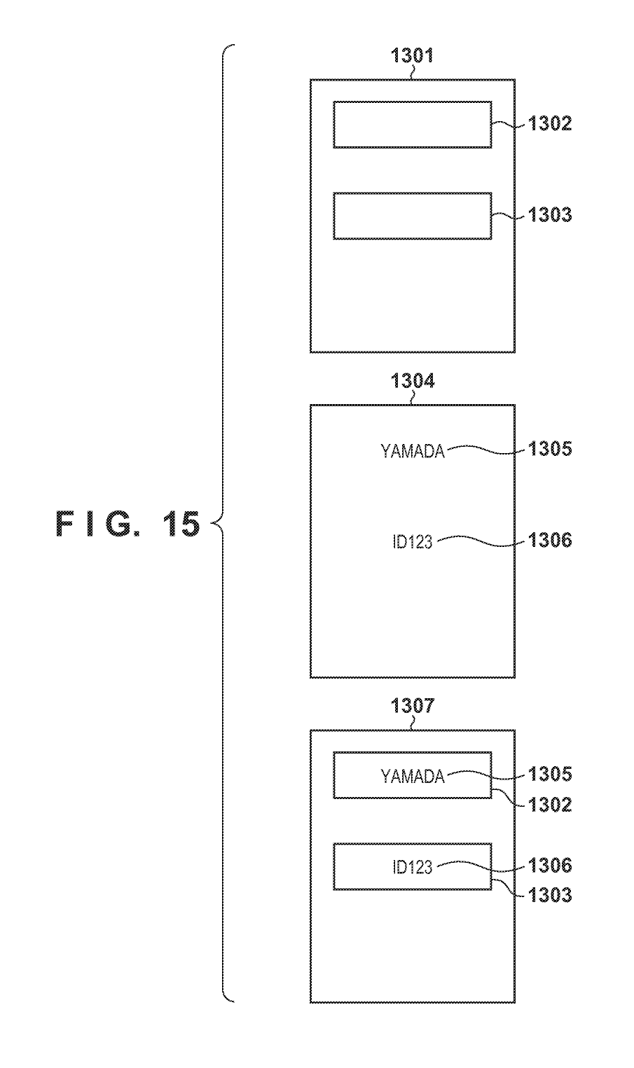

On-print processing for reading an original, modifying print contents, and printing the modified print contents on that original according to the third embodiment will be described below with reference to FIG. 14. This embodiment will explain control for adequately changing print contents in correspondence with a color attribute of each frame included in an original G. Processing to be described below is implemented when a control CPU 801 executes a control program stored in a program memory 803. FIG. 15 is a supplemental explanatory view of the operation. When the control CPU 801 receives an automatic color correction on-print command and print contents instructed from a host computer, it stores the print contents in an image memory 804, and starts the on-print processing.

In step S1201, the control CPU 801 reads an original 1301. More specifically, the original 1301, which is placed on a second feeding unit 90 and is shown in FIG. 15, is conveyed and read by an image reading unit 100, and a read original image is stored in the image memory 804. Note that the original 1301 includes two frames 1302 and 1303.

In step S1202, the control CPU 801 controls an image analysis/modification unit 850 to extract all frames from the read original image. In the example of the original 1301, the two frames 1302 and 1303 can be extracted. Frame extraction may be attained by arbitrary general processing. For example, a line including pixels of the same color, which are linearly continuous, is extracted first. Next, when four lines cross each other, and form a rectangle, they are extracted as one frame, and both a region and frame line color are stored.

In step S1203, the control CPU 801 picks up (selects) one of the frames extracted in step S1202. Subsequently, the control CPU 801 determines in step S1204 whether or not pixels in a frame region of a print content image 1304 include a color different from the frame. If the pixels include a different color, the process advances to step S1205; otherwise, the process advances to step S1206. A practical determination method will be described below. For example, since the frame color is expressed on an RGB color space, it is color-converted onto a CMYK color space first. Next, assume that the print content image 1304 includes a name 1305 in a region of the frame 1302, a color of the frame 1302 is red ((C, M, Y)=(0, 256, 0), and a color of the name 1305 is black ((C, M, Y)=(256, 256, 256)). When respective pixels have the same C:M:Y ratio of the CMYK color as that of the color of the frame except for white ((C, M, Y)=(0, 0, 0)), it is judged that they have the same color. However, since the frame and name are red and black, it is determined that they have different colors, and the process advances to step S1205. Black has CMY color values or K color value. However, if C=M=Y, black or gray is determined except for C=M=Y=0.

In step S1205, the control CPU 801 controls the image analysis/modification unit 850 to color-convert pixels except for white in the frame of the print content image stored in the image memory 804 to have the same color ratio of the frame. For example, a case will be examined below wherein since the color of the frame 1302 is red, a color ratio is C:M:Y=0:256:0, and color values of pixels in the frame of the print content image include black ((C, M, Y)=(256, 256, 256)) of the name 1305 and white ((C, M, Y)=(0, 0, 0)) of a background. Color values are color-converted to have the same color ratio with reference to the highest value of the color values. However, when the color ratio includes 0, a color other than 0 is used. That is, with reference to M=256, color conversion to C=0 and Y=0 is executed.

Next, the control CPU 801 determines in step S1206 whether or not all the frames extracted in step S1202 have been processed. If all the frames have been processed, the process advances to step S1207. If a frame to be processed still remains, the process returns to step S1203 to execute the processes of steps S1203 to S1205 for another frame. In step S1207, the control CPU 801 prints the print content image on the conveyed original 1301.

The original 1301 read by the image reading unit 100 in step S1201 is conveyed directly to conveyance rollers 40 by conveyance rollers 42 along a conveyance path 80. The conveyance rollers 40 convey the original 1301 to a transfer unit 15 to adjust timings of a toner image on the surface of a photosensitive drum 10 and the leading edge position of the original 1301. The toner image conveyed to the transfer unit 15 upon rotation of the photosensitive drum 10 is transferred onto the original 1301 by an application bias and pressure given to the transfer unit 15. Furthermore, the transfer unit 15 conveys the original 1301 to a fixing unit 50. In the fixing unit 50, heat from the rotatable heating roller 51 and a pressure from the rotatable pressure roller 52 which opposes the heating roller 51 fix the toner image on the original 1301. The original 1301 on which the toner image is fixed is conveyed to discharge rollers 60. In case of one-sided printing, the discharge rollers 60 directly convey the original 1301 outside the apparatus, and the original 1301 is stacked on a first discharge unit 70. An original 1307 shown in FIG. 15 is an example of a printed matter conveyed outside of the apparatus. The frame 1302 is printed in red, the name 1305 in the frame is printed in red, the frame 1303 is printed in black, and an ID number 1306 in the frame is printed in black.

As described above, according to this embodiment, since the printing apparatus includes the conveyance path along which an image can be printed on the read document as in the first embodiment, a color of an image to be printed can be adequately converted to print that image. That is, a printing apparatus, which can execute printing to have the same color attribute as that of the frame of the read original (preprint sheet) and is free from any work efficiency drop without requiring a user's time-consuming operation when the user need only set a plurality of different types of preprint sheets as many as the required number of copies on the original reading feeding unit together, can be provided.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-106315 filed on May 7, 2012, which is hereby incorporated by reference herein in its entirety.

What is claimed is:

1. A printing apparatus comprising:
a reading unit configured to read an original;
a color attribute determination unit configured to determine a color attribute of the original read by said reading unit;
a conversion unit configured to convert data of a print image so that a color attribute of the data of the print image corresponds to the color attribute of the original determined by said color attribute determination unit; and
a printing unit configured to execute printing on the original according to the data of the print image converted by said conversion unit.

2. The apparatus according to claim 1, wherein said color attribute determination unit determines whether or not the color attribute of the original is monochrome, and
when the color attribute of the original is monochrome, said conversion unit converts the data of the print image into monochrome data.

3. The apparatus according to claim 1, wherein said color attribute determination unit determines whether or not the color attribute of the original is single color, and
when the color attribute of the original is single color, said conversion unit converts the data of the print image into single color data.

4. The apparatus according to claim 1, wherein said color attribute determination unit determines whether or not the color attribute of the original is a color attribute of a spot ink, and
when the color attribute of the original is the color attribute of the spot ink, said conversion unit converts the data of the print image into the color attribute of the spot ink.

5. The apparatus according to claim 1, wherein said color attribute determination unit determines colors of all frames included in the original as the color attribute, and
said conversion unit converts data of the print image to be printed on regions of respective frames to conform to the colors for the respective frames determined by said color attribute determination unit.

6. The apparatus according to claim 1, further comprising:
a first feeding unit on which sheets are stacked and which is configured to feed the sheet to said printing unit;
a second feeding unit on which originals are placed and which is configured to feed the original to said reading unit;
a first conveyance path configured to convey a sheet fed from said first feeding unit to said printing unit and to discharge the sheet printed by said printing unit to a first discharge unit;
a second conveyance path configured to convey a sheet, which has been conveyed from said first feeding unit to said printing unit and a first face of which has undergone printing, to said printing unit again so as to execute printing on a second face as a reverse face of the first face, said reading unit being arranged in the vicinity of said second conveyance path, and said second conveyance path being configured to convey a sheet from said second feeding unit to said reading unit; and
a third conveyance path which is arranged at a position opposing said second conveyance path behind said reading unit, is branched from said second conveyance path, and is configured to discharge an original fed from said second feeding unit to a second discharge unit,
wherein said printing unit is configured to execute printing on a sheet fed from said first feeding unit and said reading unit is configured to read the sheet, and
said printing unit is configured to execute printing on an original fed from said second feeding unit and said reading unit is configured to read the original.

7. The apparatus according to claim 6, wherein said reading unit is arranged to be movable, and reads the first face and the second face of a sheet or an original by reading the sheet or the original conveyed along said second conveyance path and the sheet or the original conveyed along said third conveyance path.

8. A printing apparatus comprising:
a reading unit configured to read an original;
a conveyance unit configured to convey the original using a double-sided conveyance path required to execute double-sided printing;
a color attribute determination unit configured to determine a color attribute of the original read by said reading unit; and
a printing unit configured to print an image on the original conveyed by said conveyance unit according to the color attribute of the original determined by said color attribute determination unit.

9. A control method of a printing apparatus, comprising:
controlling a reading unit to read an original;
controlling a color attribute determination unit to determine a color attribute of the original read by the reading unit;
controlling a conversion unit to convert data of a print image so that a color attribute of the data of the print image corresponds to the color attribute of the original determined by the color attribute determination unit; and
controlling a printing unit to execute printing on the original according to the data of the print image converted by the conversion unit.

10. A control method of a printing apparatus, comprising:
controlling a reading unit to read an original;
controlling a color attribute determination unit to determine a color attribute of the original read by the reading unit; and
controlling a printing unit to print an image on the original conveyed along a double-sided conveyance path for double-sided printing according to the color attribute of the original determined by the color attribute determination unit.

11. A non-transitory computer-readable storage medium storing a computer program for controlling a computer to execute respective steps of a control method of a printing apparatus of claim 9.

12. A non-transitory computer-readable storage medium storing a computer program for controlling a computer to execute respective steps of a control method of a printing apparatus of claim 10.
